(19) United States
(12) Patent Application Publication
(10) Pub. No.: US 2014/0337720 A1
(43) Pub. Date: Nov. 13, 2014

(54) APPARATUS AND METHOD OF EXECUTING FUNCTION RELATED TO USER INPUT ON SCREEN

(71) Applicant: Samsung Electronics Co., Ltd., Gyeonggi-do (KR)

(72) Inventors: Ji-Hea PARK, Seoul (KR); Se-Jun SONG, Seoul (KR); Jae-Hwan KIM, Gyeonggi-do (KR)

(73) Assignee: Samsung Electronics Co., Ltd., Gyeonggi-do (KR)

(21) Appl. No.: 14/276,292

(22) Filed: May 13, 2014

(30) Foreign Application Priority Data
May 13, 2013 (KR) 10-2013-0053599

(51) Int. Cl. G06F 3/0484

(52) U.S. Cl. CPC G06F 3/04842
USPC 715/268

(57) ABSTRACT

An apparatus and method of executing a function related to a user input, and a computer-readable recording medium of recording the method are provided. The apparatus includes a touch screen configured to display data on a screen, and a controller configured to analyze handwritten text, when at least a part of an area displayed on the touch screen is selected and the handwritten text is input by an input means, to detect at least one command corresponding to the analyzed text, and to control execution of the detected command in relation to the selected area.

### PRIORITY

This application claims priority under 35 U.S.C. §119(a) to a Korean patent application filed on May 13, 2013 in the Korean Intellectual Property Office and assigned Serial No. 10-2013-0053599, the contents of which are incorporated herein by reference.

### BACKGROUND OF THE INVENTION

1. Field of the Invention

The present invention relates generally to an electronic device, and more particularly, to an apparatus and method of executing a function related to data input or selected by a user on a screen of an electronic device.

2. Description of the Related Art

User Interfaces (UIs) have increasingly diversified for electronic devices, inclusive of a touch or hovering hand input or an electronic pen (e.g. a stylus pen) on a touch screen as well as input on a conventional keypad. Along with the rapid development of technology, many input techniques have been developed, such as user gestures, voice, eye (or iris) movement, and vital signals.

As mobile devices are equipped with many sophisticated functions, a user cannot immediately execute an intended function in relation to data displayed on a screen during execution of a specific application. Rather, the user inconveniently experiences two or more steps including detection of an additional menu (e.g. a sub-menu) and execution of the intended function.

Accordingly, there exists a need for a method for intuitively executing various related functions in relation to data displayed on a screen by a user's direct input.

### SUMMARY OF THE INVENTION

Aspects of the present invention are to address at least the above-mentioned problems and/or disadvantages and to provide at least the advantages described below. Accordingly, an aspect of the present invention is to provide an apparatus and method of executing, when a user selects at least a part of an entire area displayed on a screen and applies an input on the screen, a function corresponding to the user input in relation to the selected area on the screen in an electronic device, and a computer-readable recording medium of recording the method.

Another aspect of the present invention is to provide an apparatus and method of executing a function related to a user input on a screen, in which when a user selects at least a part of an entire area displayed on a screen, at least one function corresponding to the data type of the selected area is executed or a user selects one of available functions corresponding to the data type on the screen and executes the selected function, and a computer-readable recording medium of recording the method.

Another aspect of the present invention is to provide an apparatus and method of executing, when a user selects at least a part of an entire area displayed on a screen and applies a handwriting input on the screen, a function corresponding to the handwriting input in relation to the selected area on the screen in an electronic device, and a computer-readable recording medium of recording the method.

In accordance with an aspect of the present invention, an apparatus of executing a function related to a user input includes a touch screen configured to display data on a screen, and a controller configured to analyze handwritten text, when at least a part of an area displayed on the touch screen is selected and the handwritten text is input by an input means, to detect at least one command corresponding to the analyzed text, and to control execution of the detected command in relation to the selected area.

In accordance with another aspect of the present invention, an apparatus of executing a function related to a user input includes a touch screen configured to display data on a screen, and a controller configured to analyze handwritten text, when the handwritten text is input on the touch screen by an input means, to detect at least one command corresponding to the analyzed text, and to control execution of the detected command in relation to an entire area displayed on the touch screen.

In accordance with another aspect of the present invention, an apparatus of executing a function related to a user input includes a touch screen configured to display data on a screen, and a controller configured, when at least a part of an entire area displayed on the touch screen is selected by an input means, to analyze the type of data included in the selected area, to detect at least one command corresponding to the analyzed data type, and to control execution of the detected command in relation to the data included in the selected area.

In accordance with an aspect of the present invention, a method of executing a function related to a user input includes detecting selection of at least a part of an entire area displayed on a touch screen by an input means, receiving handwritten text on the touch screen, analyzing the handwritten text, detecting at least one command corresponding to the analyzed text, and executing the detected command in relation to the selected area.

In accordance with another aspect of the present invention, a method of executing a function related to a user input includes receiving handwritten text on a touch screen from an input means, analyzing the handwritten text, detecting at least one command corresponding to the analyzed text, and executing the detected command in relation to an entire area displayed on the touch screen.

In accordance with another aspect of the present invention, a method of executing a function related to a user input includes detecting selection of at least a part of an entire area displayed on a touch screen by an input means, analyzing the type of data included in the selected area, detecting at least one command corresponding to the analyzed data type, and executing the detected command in relation to the data included in the selected area.

Other aspects, advantages, and salient features of the invention will become apparent to those skilled in the art from the following detailed description, which, taken in conjunction with the annexed drawings, discloses embodiments of the invention.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a block diagram of a portable terminal as an electronic device according to an embodiment of the present invention;

FIG. 2 is a front perspective view of a portable terminal according to an embodiment of the present invention;

FIG. 3 is a rear perspective view of a portable terminal according to an embodiment of the present invention;

FIG. 4 is a block diagram of an apparatus of executing a function related to a user input on a screen according to a first embodiment of the present invention;

FIG. 5 illustrates an operation of executing a function related to a user input on a screen according to the first embodiment of the present invention;

FIG. 6 illustrates an operation of executing a function related to a user input on a screen according to the first embodiment of the present invention;

FIG. 7 illustrates execution of a function related to a user input on a screen according to the first embodiment of the present invention;

FIG. 8 illustrates execution of a function related to a user input on a screen according to the first embodiment of the present invention;

FIG. 9 is a block diagram of an apparatus of executing a function related to a user input on a screen according to a second embodiment of the present invention;

FIG. 10 illustrates an operation of executing a function related to a user input on a screen according to the second embodiment of the present invention;

FIGS. 11A, 11B, 11C and 11D illustrate execution of a function related to a user input on a screen according to the second embodiment of the present invention;

FIG. 12 illustrates execution of a function related to a user input on a screen according to the second embodiment of the present invention;

FIG. 13 illustrates execution of a function related to a user input on a screen according to the second embodiment of the present invention;

FIGS. 14A and 14B illustrate execution of a function related to a user input on a screen according to the second embodiment of the present invention; and

FIGS. 15A, 15B and 15C illustrate execution of a function related to a user input on a screen according to the second embodiment of the present invention.

Throughout the drawings, like reference numerals will be understood to refer to like parts, components, and structures.

### DETAILED DESCRIPTION OF EMBODIMENTS OF THE INVENTION

The following description with reference to the accompanying drawings is provided to assist in a comprehensive understanding of embodiments of the invention as defined by the claims and their equivalents. Those of ordinary skill in the art will recognize that various changes and modifications of the embodiments described herein can be made without departing from the scope and spirit of the invention. In addition, descriptions of well-known functions and constructions are omitted for the sake of clarity and conciseness.

The terms and words used in the following description and claims are not limited to their dictionary meanings, but, are merely used to enable a clear and consistent understanding of the invention. Accordingly, it should be apparent to those skilled in the art that the following description of embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the intended effect of the characteristic.

An electronic device herein is any device equipped with a touch screen, which may also be referred to as a portable terminal, a mobile terminal, a communication terminal, a portable communication terminal, or a portable mobile terminal. For example, an electronic device includes a smartphone, a portable phone, a game console, a TeleVision (TV), a display device, a head unit for a vehicle, a laptop computer, a tablet Personal Computer (PC), a Personal Media Player (PMP), a Personal Digital Assistant (PDA), a navigator, an Automatic Teller Machine (ATM) of a bank, and a Point Of Sale (POS) device of a shop. In the present invention, an electronic device is a flexible device or a flexible display device.

The following description will be given with the appreciation that a portable terminal is being used as an electronic device and some components are omitted or modified in the general configuration of the electronic device.

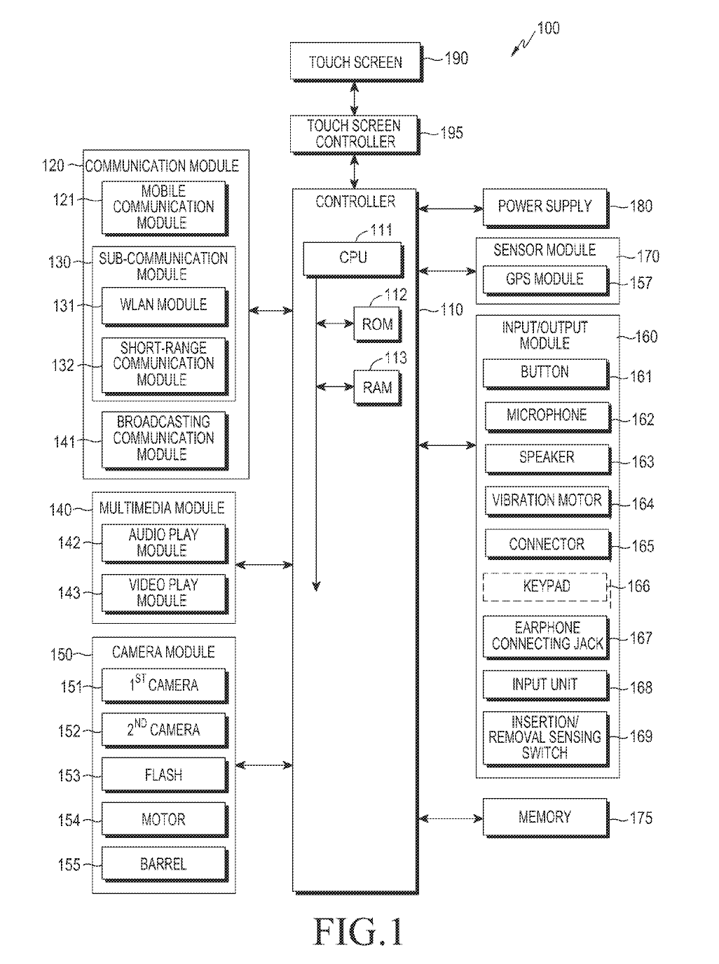

FIG. 1 is a block diagram of a portable terminal as an electronic device according to an embodiment of the present invention.

Referring to FIG. 1, a portable terminal 100 is connected to an external electronic device (not shown) through at least one of a communication module 120, a connector 165, and an earphone connector jack 167. The external electronic device is any of a variety of devices that can be detachably connected to the portable terminal 100 by wire, such as an earphone, an external speaker, a Universal Serial Bus (USB) memory, a charger, a cradle, a docking station, a Digital Multimedia Broadcasting (DMB) antenna, a mobile payment device, a health care device such as a blood sugar meter, a game console, and a vehicle navigator. The external electronic device may also be a device wirelessly connectable to the portable terminal 100 by short-range communication, such as a Bluetooth® communication device, a Near Field Communication (NFC) device, a Wireless Fidelity (Wi-Fi) Direct communication device, and a wireless Access Point (AP). The portable terminal 100 is connected to another portable terminal or electronic device by wire or wirelessly, such as a portable phone, a smart phone, a tablet Personal Computer (PC), a desktop PC, or a server.

The portable terminal 100 includes at least one touch screen 190 and at least one touch screen controller 195. The portable terminal 100 further includes a controller 110, the communication module 120, a multimedia module 140, a camera module 150, an Input/Output (I/O) module 160, a sensor module 170, a memory (storage) 175, and a power supply 180. The communication module 120 includes a mobile communication module 121, a sub-communication module 130, and a broadcasting communication module 141. The sub-communication module 130 includes at least one of a Wireless Local Area Network (WLAN) module 131 and a short-range communication module 132. The multimedia module 140 includes at least one of an audio play module 142 and a video play module 143. The camera module 150 includes at least one of a first camera 151 and a second camera 152, and the I/O module 160 includes at least one of buttons 161, a microphone 162, a speaker 163, a vibration device 164, the connector 165, and a keypad 166.

The controller 110 includes a Central Processing Unit (CPU) 111, a Read Only Memory (ROM) 112 that stores a control program to control the portable terminal 100, and a Random Access Memory (RAM) 113 that stores signals or data received from the outside of the portable terminal 100 or for use as a memory space for an operation performed by the portable terminal 100. The CPU 111 includes one or more cores. The CPU 111, the ROM 112, and the RAM 113 are connected to one another through an internal bus.

The controller 110 controls the communication module 120, the multimedia module 140, the camera module 150, the I/O module 160, the sensor module 170, the memory 175, the power supply 180, the touch screen 190, and the touch screen controller 195.

In an embodiment of the present invention, when a user selects a specific area or inputs a specific character by handwriting on a screen of the touch screen 190 that is displaying data by means of a touch input means such as a finger or a pen, the controller 110 senses the user selection or the user input through an input unit 168 and performs a function corresponding to the user selection or the user input.

For example, if the user selects a specific area and then inputs text by handwriting using the user input means, the controller 110 controls execution of a function corresponding to the input text in relation to the selected area. Upon selection of a specific area in a command recognition mode, the controller 110 analyzes the data type of the selected area and controls execution of a function corresponding to the analyzed data type in relation to the area.

In the present invention, the user input is on the touch screen 190, a gesture input through the camera module 150, a switch or button input through the buttons 161 or the keypad 166, and a voice input through the microphone 162.

The controller 110 senses a user input event such as a hovering event that is generated when the input unit 168 approaches the touch screen 190 from above or is located nearby above the touch screen 190. Upon generation of a user input event, the controller 110 controls a program function (e.g. switching to an input mode or a function execution mode) corresponding to the user input event.

The controller 110 outputs a control signal to the input unit 168 or the vibration device 164. The control signal includes information about a vibration pattern and thus the input unit 168 or the vibration device 164 generates vibrations according to the vibration pattern. The information about the vibration pattern specifies, for example, the vibration pattern itself or an ID of the vibration pattern, or this control signal includes only a vibration generation request.

The portable terminal 100 includes at least one of the mobile communication module 121, the WLAN module 131, and the short-range communication module 132 according to its capabilities.

The mobile communication module 121 connects the portable terminal 100 to an external electronic device through one or more antennas (not shown) by mobile communication under the control of the controller 110. The mobile communication module 121 transmits wireless signals to or receives wireless signals from a portable 20 phone (not shown), a smart phone (not shown), a tablet PC (not shown), or another electronic device (not shown) that has a phone number input to the portable terminal 100, for a voice call, a video call, a Short Message Service (SMS), or a Multimedia Messaging Service (MMS).

The sub-communication module 130 includes at least one of the WLAN module 131 and the short-range communication module 132. For example, sub-communication module 130 includes only the WLAN module 131, only the short-range communication module 132, or both the WLAN module 131 and the short-range communication module 132.

The WLAN module 131 is connected to the Internet under the control of the controller 110 in a location where a wireless AP (not shown) is installed. The WLAN module 131 supports the WLAN standard, Institute of Electrical and Electronics Engineers (IEEE) 802.11x. The short-range communication module 132 conducts short-range wireless communication between the portable terminal 100 and an external electronic device under the control of the controller 110. The short-range communication conforms to Bluetooth®, Infrared Data Association (IrDA), Wi-Fi Direct, and Near Field Communication (NFC).

The broadcasting communication module 141 receives a broadcast signal (e.g., a TV broadcast signal, a radio broadcast signal, or a data broadcast signal) and additional broadcasting information (e.g., an Electronic Program Guide (EPG) or Electronic Service Guide (ESG)) from a broadcasting station through a broadcasting communication antenna (not shown) under the control of the controller 110.

The multimedia module 140 includes the audio play module 142 or the video play module 143. The audio play module 142 opens a stored or received digital audio file (e.g., a file having such an extension as mp3, wma, ogg, or way) under the control of the controller 110. The video play module 143 opens a stored or received digital video file (e.g., a file having an extension such as mpeg, mpg, mp4, avi, mov, or mkv) under the control of the controller 110.

The multimedia module 140 is incorporated into the controller 110. The camera module 150 includes at least one of the first camera 151 and the second camera 152, to capture a still image or a video under the control of the controller 110. The camera module 150 includes at least one of a barrel 155 to zoom in or zoom out an object during capturing the object, a motor 154 to control movement of the barrel 155, and a flash 153 to provide an auxiliary light source required for capturing an image. The first camera 151 is disposed on the front surface of the portable terminal 100, while the second camera 152 is disposed on the rear surface of the device 100.

The I/O module 160 includes at least one of the plurality of buttons 161, the at least one microphone 162, the at least one speaker 163, the at least one vibration device 164, the connector 165, the keypad 166, the earphone connector jack 167, and the input unit 168. The I/O module 160 is not limited thereto and a cursor control such as a mouse, a track ball, a joystick, or cursor directional keys is provided to control movement of a cursor on the touch screen 190.

The buttons 161 are formed on the front surface, a side surface, or the rear surface of a housing (or case) of the portable terminal 100, and includes at least one of a power/lock button, a volume button, a menu button, a home button, a back button, and a search button. The microphone 162 receives a voice or a sound and converts the received voice or sound to an electrical signal under the control of the controller 110. The speaker 163 outputs sounds corresponding to various signals or data such as wireless, broadcast, digital audio, and digital video data, to the outside of the portable terminal 100 under the control of the controller 110. The speaker 163 outputs sounds corresponding to functions such as a button manipulation sound, a ringback tone, and a voice from the other party. in a call, performed by the portable terminal 100. One or more speakers 163 are disposed at an appropriate position or positions of the housing of the portable terminal 100.

The vibration device 164 converts an electrical signal to a mechanical vibration under the control of the controller 110. For example, the vibration device 164 operates when the portable terminal 100 receives an incoming voice call or video call from another device (not shown) in a vibration mode. One or more vibration devices 164 are mounted inside the housing of the portable terminal 100. The vibration device 164 operates in response to a user input on the touch screen 190.

The connector 165 is used as an interface to connect the portable terminal 100 to an external electronic device (not shown) or a power source (not shown). The controller 110 transmits data stored in the memory 175 to the external electronic device or receives data from the external electronic device via a cable connected to the connector 165. The portable terminal 100 receives power or charge a battery (not shown) from the power source via the cable connected to the connector 165.

The keypad 166 receives a key input from the user to control the portable terminal 100. The keypad 166 includes a physical keypad (not shown) formed in the portable terminal 100 or a virtual keypad (not shown) displayed on the touch screen 190. The physical keypad may not be provided according to the capabilities or configuration of the portable terminal 100. An earphone (not shown) is insertable into the earphone connector jack 167 and thus connectable to the portable terminal 100.

The input unit 168 is inserted and maintained in the portable terminal 100. When the input unit 168 is used, it is extended or removed from the portable terminal 100. An insertion/removal sensing switch 169 is provided in an internal area of the portable terminal 100 into which the input unit 168 is inserted, in order to operate in response to insertion and removal of the input unit 168. The insertion/removal sensing switch 169 outputs signals corresponding to insertion and removal of the input unit 168 to the controller 110. The insertion/removal sensing switch 169 is configured so as to directly or indirectly contact the input unit 168, when the input unit 168 is inserted. Therefore, the insertion/removal sensing switch 169 outputs, to the controller 110, a signal corresponding to insertion or removal of the input unit 168 (i.e. a signal indicating insertion or removal of the input unit 168) depending on whether the insertion or removal of the input unit 168 contacts the input unit 168.

The sensor module 170 includes at least one sensor to detect a state of the portable terminal 100. For example, the sensor module 170 includes a proximity sensor that detects whether the user is close to the portable terminal 100, an illuminance sensor that detects the amount of ambient light around the portable terminal 100, a motion sensor that detects a motion of the portable terminal 100 (e.g., rotation, acceleration or vibration of the portable terminal 100), a geo-magnetic sensor that detects a point of the compass of the portable terminal 100 using the Earth's magnetic field, a gravity sensor that detects the direction of gravity, an altimeter that detects an altitude by measuring the air pressure, and a Global Positioning System (GPS) module 157.

The GPS module 157 receives signal waves from a plurality of GPS satellites (not shown) in Earth's orbit and calculates a position of the portable terminal 100 based on the Time of Arrivals (ToAs) of satellite signals from the GPS satellites to the portable terminal 100.

The memory 175 stores input/output signals or data in accordance with operations of the communication module 120, the multimedia module 140, the camera module 150, the I/O module 160, the sensor module 170, and the touch screen 190 under the control of the controller 110. The memory 175 stores a control program to control the portable terminal 100 or the controller 110, and applications.

The term “memory” covers the memory 175, the ROM 112 and the RAM 113 within the controller 110, or a memory card (not shown) (e.g. a Secure Digital (SD) card or a memory stick) mounted to the portable terminal 100. The memory includes a non-volatile memory, a volatile memory, a Hard Disk Drive (HDD), or a Solid State Drive (SSD).

The memory 175 stores applications having various functions such as navigation, video call, game, and time-based alarm applications, images used to provide GUIs related to the applications, user information, text, databases or data related to a method of processing a touch input, background images (e.g. a menu screen, and a waiting screen) or operation programs required to operate the terminal 100, and images captured by the camera module 150.

In an embodiment of the present invention, the memory 175 stores data about at least one function corresponding to a data type or handwritten text on a screen.

The memory 175 is a machine-readable medium (e.g. a computer-readable medium). A machine-readable medium provides data to a machine which performs a specific function. The memory 175 includes a volatile medium and a non-volatile medium. The media transfers commands detectable by a physical device that reads the commands to the machine

The machine-readable medium includes, but not limited to, at least one of a floppy disk, a flexible disk, a hard disk, a magnetic tape, a Compact Disk Read Only Memory (CD-ROM), an optical disk, a punch card, a paper tape, a Random Access Memory (RAM), a Programmable Read Only Memory (PROM), an Erasable PROM (EPROM), and a Flash-EPROM.

The power supply 180 supplies power to one or more batteries mounted in the housing of the portable terminal 100 under the control of the controller 110. The one or more batteries supply power to the portable terminal 100. The power supply 180 supplies power received from an external power source via the cable connected to the connector 165 to the portable terminal 100. The power supply 180 may also supply power received wirelessly from the external power source to the portable terminal 100 by a wireless charging technology.

The portable terminal 100 includes the at least one touch screen 190 that provides Graphical User Interfaces (GUIs) corresponding to various services such as call, data transmission, broadcasting, and photo shot. The touch screen 190 outputs an analog signal corresponding to at least one user input to a GUI to the touch screen controller 195.

The touch screen 190 receives at least one user input through a user's body such as a finger, or the input unit 168 such as a stylus pen and an electronic pen. The touch screen 190 is implemented as, for example, a resistive type, a capacitive type, an infrared type, an acoustic wave type, or in a combination thereof.

The touch screen 190 includes at least two touch panels that sense a finger's touch or proximity and a touch or proximity of the input unit 168 in order to receive inputs of the finger and the input unit 168. The at least two touch panels provide different output values to the touch screen controller 195, and the touch screen controller 195 distinguishes a finger's input to the touch screen 190 from an input of the input unit 168 to the touch screen 190 by identifying the different values received from the at least two touch screen panels.

The touch includes a non-contact touch (e.g. a detectable gap between the touch screen 190 and the user's body part or a touch input means is 1 mm or less), not limited to contacts between the touch screen 190 and the user's body part or the touch input means. The gap detectable to the touch screen 190 may vary according to the capabilities or configuration of the portable terminal 100.

The touch screen controller 195 converts an analog signal received from the touch screen 190 to a digital signal. The controller 110 controls the touch screen 190 using the digital signal received from the touch screen controller 195. The touch screen controller 195 controls a hovering gap or distance as well as a user input position by detecting a value output from the touch screen 190 (e.g. a current value), converts the hovering gap or distance to a digital signal (e.g. a Z coordinate), and provides the digital signal to the controller 110. The touch screen controller 195 detects a value output from the touch screen 190 such as a current value, detects pressure applied to the touch screen 190 by the user input means, converts the detected pressure value to a digital signal, and provides the digital signal to the controller 110.

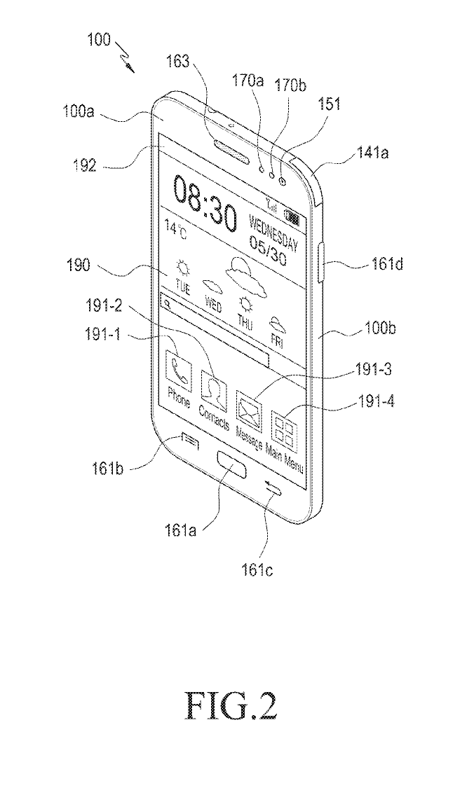

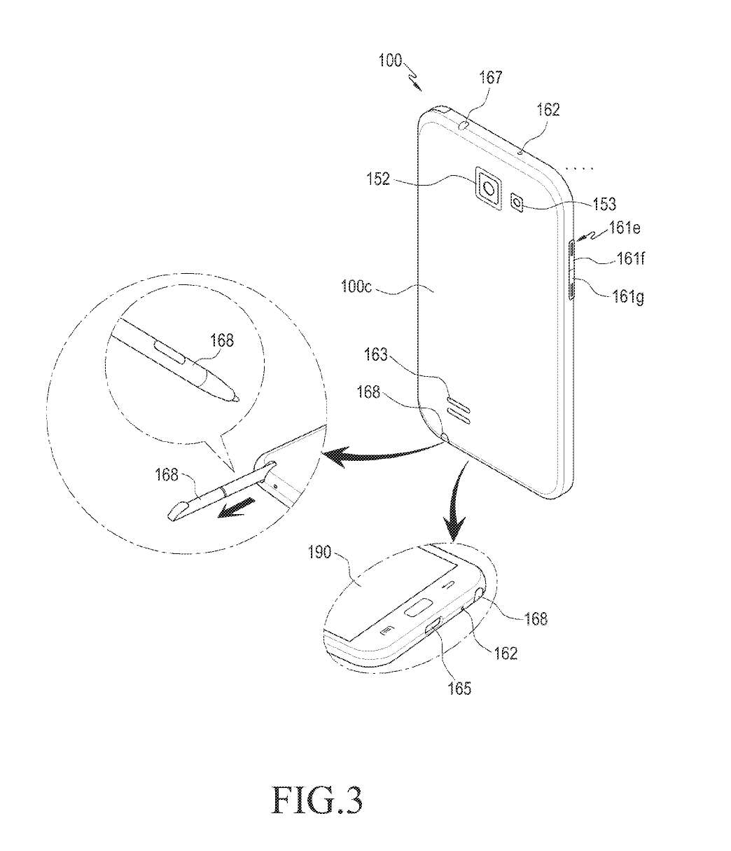

FIGS. 2 and 3 are front and rear perspective views, respectively, of a portable terminal according to an embodiment of the present invention.

Referring to FIGS. 2 and 3, the touch screen 190 is disposed at the center of the front surface 101 of the portable terminal 100, occupying almost the entirety of the front surface 101. In FIG. 2, a main home screen is displayed on the touch screen 190, by example. The main home screen is the first screen to be displayed on the touch screen 190, when the portable terminal 100 is powered on. When the portable terminal 100 has different home screens of a plurality of pages, the main home screen is the first of the home screens of the plurality of pages. Information such as shortcut icons 191-1, 191-2 and 191-3 used to execute frequently used applications, a main menu switch key 191-4, time, and weather is displayed on the home screen. A menu screen is displayed on the touch screen 190 upon user selection of the main menu switch key 191-4. A status bar 192 is displayed at the top of the touch screen 190 in order to indicate states of the portable terminal 100 such as a battery charged state, a received signal strength, and a current time.

A home button 161a, a menu button 161b, and a back button 161c are formed at the bottom of the touch screen 190. The home button 161a is used to display the main home screen on the touch screen 190. For example, the main home screen is displayed on the touch screen 190 upon selection of the home button 161 a while any home screen other than the main home screen or the menu screen is displayed on the touch screen 190.

The main home screen illustrated in FIG. 2 is displayed on the touch screen 190 upon selection of the home button 161 a during execution of applications on the home screen 190. The home button 161a may also be used to display recently used applications or a task manager on the touch screen 190.

The menu button 161b provides link menus that can be displayed on the touch screen 190. The link menus include a widget adding menu, a background changing menu, a search menu, an edit menu, and an environment setting menu.

The back button 161c displays the screen previous to a current screen or ends the latest used application.

The first camera 151, an illuminance sensor 170a, and a proximity sensor 170b are arranged at a corner of the front surface 101 of the portable terminal 100, whereas the second camera 152, a flash 153, and the speaker 163 are arranged on the rear surface 103 of the portable terminal 100.

For example, referring to FIGS. 2 and 3, a power/lock button 161d, a volume button 161e including a volume up button 161f and a volume down button 161g, a terrestrial DMB antenna 141a that receives a broadcast signal, and one or more microphones 162 are disposed on side surfaces 102 of the portable terminal 100. The DMB antenna 141a is fixedly or detachably mounted to the portable terminal 100.

The connector 165 is formed on the bottom side surface of the portable terminal 100. The connector 165 includes a plurality of electrodes and is connected to an external device by wire. The earphone connector jack 167 is formed on the top side surface of the portable terminal 100, in order to allow an earphone to be inserted.

The input unit 168 is mounted to the bottom side surface of the portable terminal 100. The input unit 168 is inserted and maintained inside the portable terminal 100. When the input unit 168 is used, the input unit is extended and removed from the portable terminal 100.

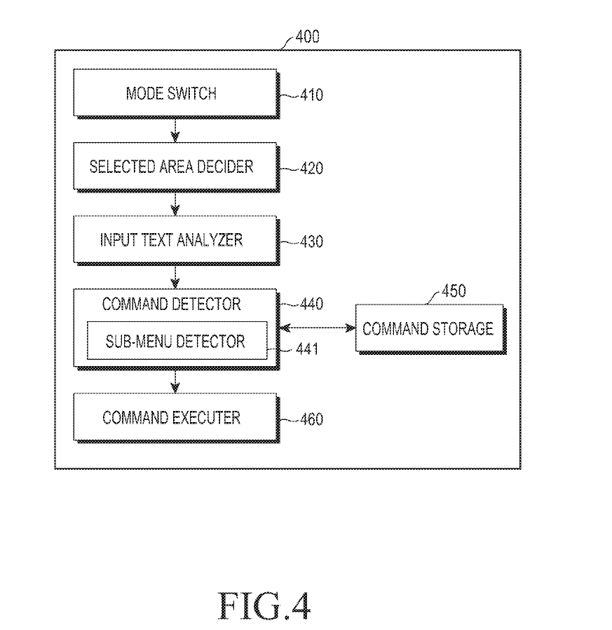

FIG. 4 is a block diagram of an apparatus of executing a function related to a user input on a screen according to a first embodiment of the present invention. Referring to FIG. 4, an apparatus 400 of the present invention includes a mode switch 410, a selected area decider 420, an input text analyzer 430, a command detector 440, a command storage 450, and a command executer 460.

The mode switch 410 sets an on-screen input mode in which a user may select an area or input a character by handwriting on a screen using an input means. When a handwriting recognition mode or a command recognition mode is set by the mode switch 410, a user input or a user-selected area on a screen is analyzed and then a related function according to an embodiment of the present invention is performed. While it is preferred that an area is selected or a character is input after the mode switch 410 switches an input mode, the present invention is not limited thereto. That is, functions may be performed without any mode switching in an embodiment of the present invention.

When the user selects a specific area on an entire screen by a user input applied through an input means, the selected area decider 420 determines the selected area. The user may select an area by a hand touch or a pen touch. The user may select the area by drawing a closed loop or select the area from among a plurality of areas. In an embodiment of the present invention, if no user selection is made, the entire area of a screen is regarded as selected.

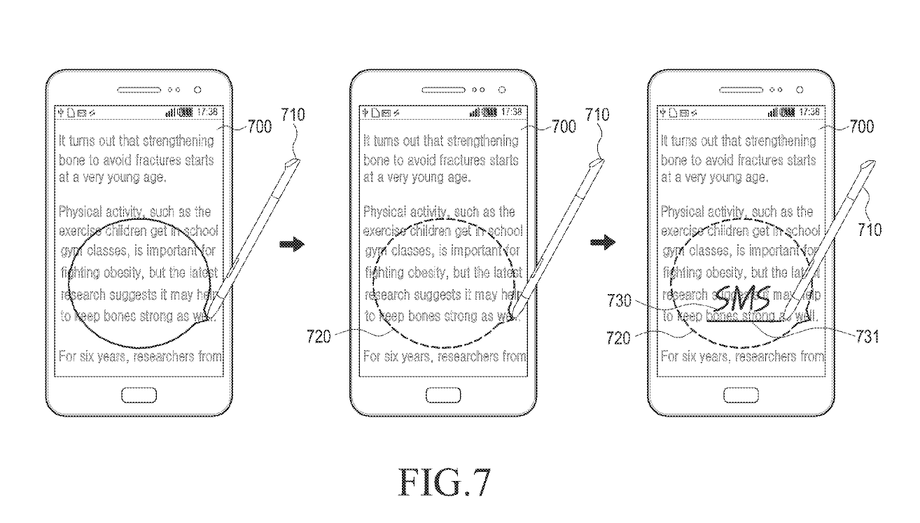

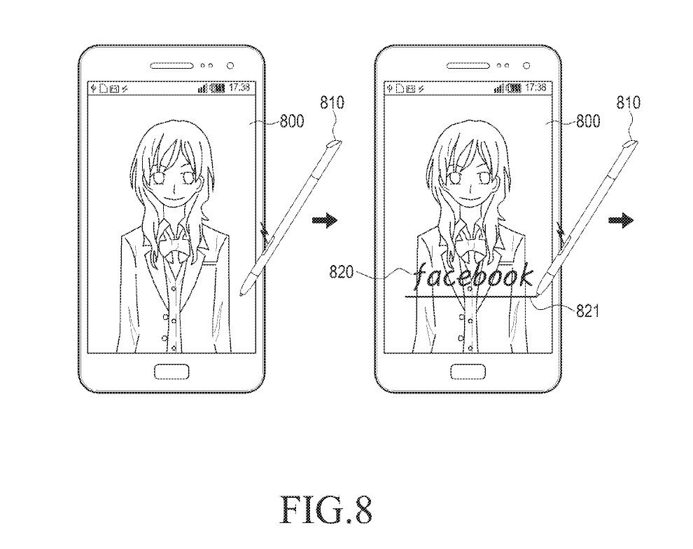

The input text analyzer 430 analyzes a character that the user has input using an input means. When the user inputs text by handwriting as illustrated in FIGS. 7 and 8, the input text analyzer 430 includes a handwriting recognition means to identify an input character or symbol in a character table.

The command detector 440 detects a command corresponding to the character (or symbol) identified by the input text analyzer 430 in a mapping table stored in the command storage 450. The command may request execution of a specific function in an electronic device, a specific application installed in the electronic device, or a specific function of a specific application along with execution of the specific application.

For example, when the user inputs text ‘sms’ by handwriting as illustrated in FIG. 7, the input text analyzer 430 identifies the handwriting ‘sms’ and the command detector 440 executes a Short Message Service (SMS) program as a function corresponding to the identified text ‘sms’.

The command detector 440 includes a sub-menu detector 441 which detects a corresponding function among sub-menus provided by an application that displays data on a current screen, in another embodiment of the present invention. That is, the sub-menu detector 441 searches for a corresponding function among functions of sub-menus provided by the currently executed application, rather than detecting a function corresponding to the identified character among functions provided by many applications available in the electronic device. Search speed and accuracy can be increased as the corresponding function is detected in the sub-menus.

The command storage 450 stores commands mapped to input characters. For example, a command that executes the SMS service is mapped to the text ‘sms’.

The command executer 460 executes the command detected by the command detector 440. When the command is executed, the selected area determined by the selected area decider 420 is considered in an embodiment of the present invention. For example, if the command requests execution of the SMS service, text included in the selected area is automatically inserted into a body of an SMS transmission screen.

The components of the apparatus 400 are shown separately in FIG. 4 to indicate that they are functionally and logically separated. However, the components of the apparatus 400 are not necessarily configured as physical separate devices or codes.

Each function unit may refer to a functional and structural combination of hardware that implements the technical spirit of the present invention and software that operates the hardware. For example, each function unit is a logical unit of a specific code and hardware resources needed to implement the code. Those skilled in the art will readily understand that a function unit is not always a physically connected code or a single type of hardware.

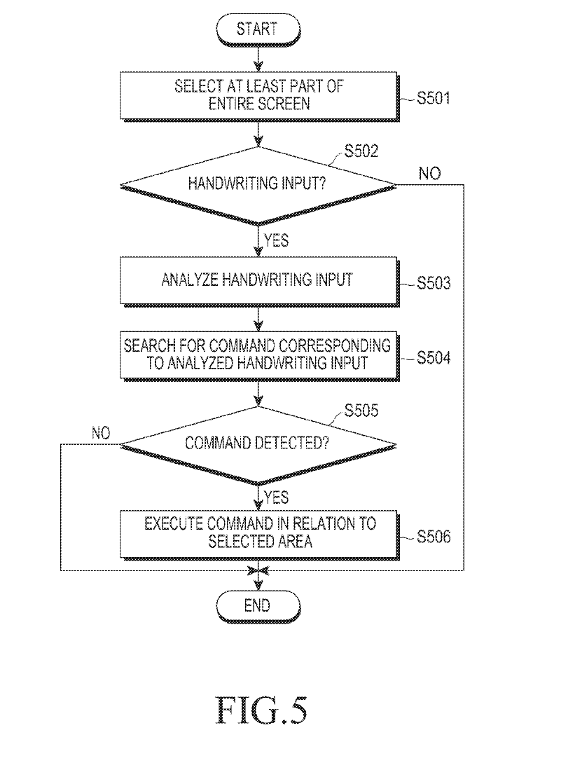

FIG. 5 illustrates an operation of executing a function related to a user input on a screen according to the first embodiment of the present invention. Referring to FIG. 5, a specific application is being executed in an electronic device and a user selects at least a part of the entire area of a currently displayed screen by a user input means in step S501. When the user inputs text by handwriting in step S502, the handwritten text is analyzed and identified in step S503.

A command corresponding to the identified text is searched for among pre-stored commands in step S504. When the command corresponding to the identified text is detected in step S505, the command is executed in relation to the selected area in step S506. When the command is not detected in step S505, the process ends.

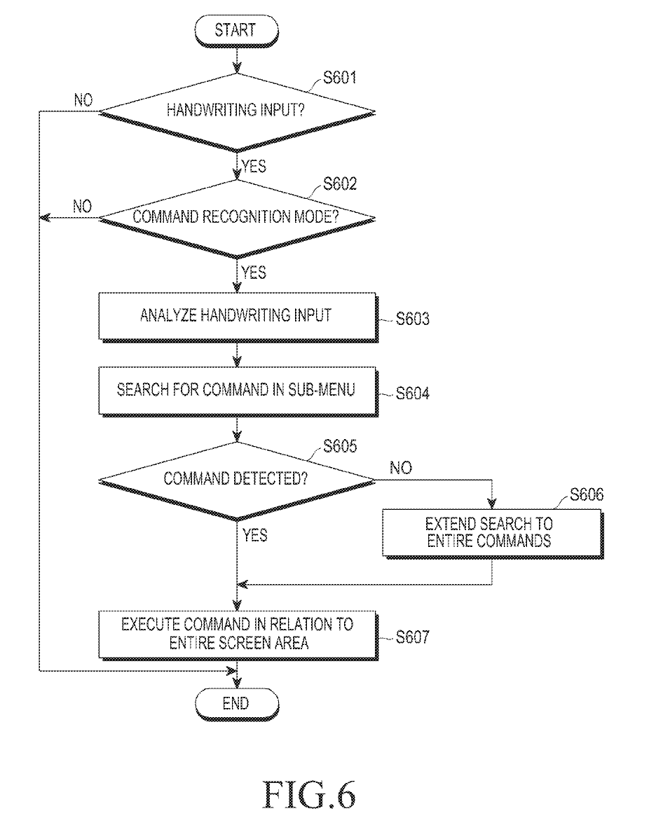

FIG. 6 illustrates an operation of executing a function related to a user input on a screen according to the first embodiment of the present invention. Referring to FIG. 6, when a specific application is being executed in an electronic device and a user inputs text by handwriting in step S601, if the input mode of the current application is a command recognition mode in step S602, the handwritten text is analyzed and identified in step S603.

A command corresponding to the identified text is searched for among pre-stored commands in step S604. The command is detected from among commands of options or sub-menus of the current application in step S604. In the absence of the command corresponding to the identified text among the commands of the options or sub-menus of the application in step S605, commands are searched to detect the command corresponding to the identified text in step S606.

When the command corresponding to the identified text is detected, the command is executed in relation to an entire area of the current screen in step S607.

FIG. 7 illustrates execution of a function related to a user input on a screen according to the second embodiment of the present invention. Referring to FIG. 7, a user selects a specific area 720 on a screen 700 of an electronic device by means of a user input means 710 (e.g. an electronic pen in FIG. 7). The area is selected in various manners. In FIG. 7, the area is shown as selected by drawing a closed loop around the area.

When the user inputs text 730 by handwriting using the user input means after selecting the area, the handwritten text 730 is analyzed and thus identified. For example, the text 730 is identified as ‘sms’ in FIG. 7, and a command corresponding to the identified text is detected in a pre-stored table. For example, the command corresponding to the identified text may correspond to execution of an SMS program. Accordingly, the SMS program is executed and thus text included in the selected area is inserted as a text body to be transmitted in the SMS service.

When text is input by handwriting, a marking such as an underline 731 or a period ‘.’ is used to indicate that the text input is finished or the input text corresponds to a command. Therefore, when the user inputs the text ‘sms’ by handwriting and draws the underline 731 as illustrated in FIG. 7, it is determined that the text input has been completed and the input text is analyzed. In another embodiment of the present invention, when the user inputs the text ‘sms’ by handwriting and draws the underline 731 as illustrated in FIG. 7, a simple text input mode is switched to the command recognition mode so that a command corresponding to the current handwritten text is executed. An additional marking input to handwritten text is set in various forms. For example, the additional marking is an underline as illustrated in FIG. 7 or a special character or symbol such as a period ‘.’.

In another embodiment of the present invention, when no additional input has not been received for a time after handwritten text is input, it is determined that the text input has been completed, and an additional marking is not used to indicate completion of text input.

FIG. 8 illustrates execution of a function related to a user input on a screen according to the first embodiment of the present invention. Referring to FIG. 8, a user may input text 820 by handwriting using a user input means 810 (e.g. an electronic pen) on a screen 800 of an electronic device.

If the command recognition mode is set, the handwritten text 820 is analyzed and thus identified. For example, the text 820 is identified as ‘facebook’ in FIG. 8, and a command corresponding to the identified text is detected in a pre-stored table. For example, the command corresponding to the identified text is execution of a Social Networking Service (SNS) program called ‘facebook’. Accordingly, the SNS program is executed. Unless a specific area is selected, the entire data (or image) displayed on the screen is posted to a user account in the SNS program, determining that the entire area has been selected.

In an embodiment of the present invention, when text is input by handwriting, a marking such as an underline 821 or a period ‘.’ is used to indicate that the text input is finished or the input text corresponds to a command, as previously described with reference to FIG. 7. Therefore, when the user inputs the text ‘facebook’ by handwriting and draws the underline 821 as illustrated in FIG. 8, it is determined that the text input has been completed and the input text is analyzed. In another embodiment of the present invention, when the user inputs the text ‘facebook’ by handwriting and draws the underline 821 as illustrated in FIG. 8, the simple text input mode is switched to the command recognition mode so that a command corresponding to the current handwritten text is executed. An additional marking input to handwritten text is set in various forms. For example, the additional marking is an underline as illustrated in FIG. 8 or a special character or symbol such as a period ‘.’, and a check mark ‘I’.

In another embodiment of the present invention, when no additional input has not been received for a time after handwritten text is input, it is determined that the text input has been completed, as previously described with reference to FIG. 7. In this case, an additional marking is not used to indicate completion of text input.

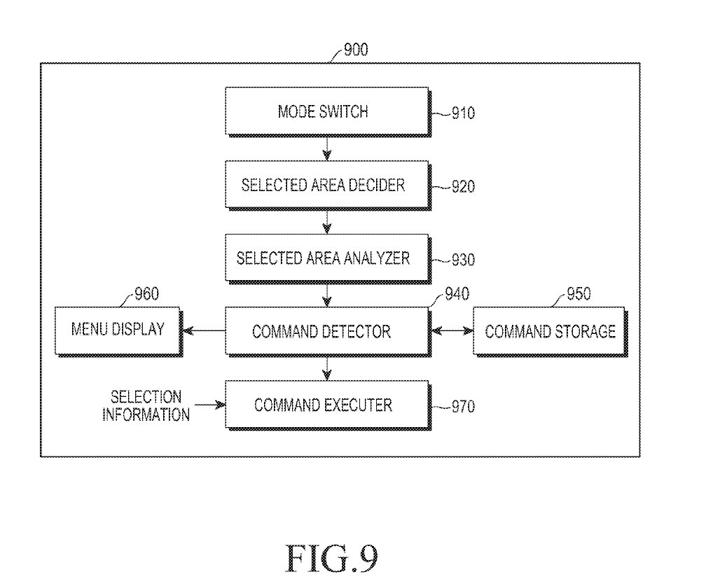

FIG. 9 is a block diagram of an apparatus of executing a function related to a user input on a screen according to a second embodiment of the present invention. Referring to FIG. 9, an apparatus 900 of the present invention includes a mode switch 910, a selected area decider 920, a selected area analyzer 930, a command detector 940, a command storage 950, a menu display 960, and a command executer 970.

The mode switch 910 sets an on-screen input mode in which a user may select an area on a screen using an input means to execute a command. When a command recognition mode is set by the mode switch 910, a user input or a user-selected area on a screen is analyzed and then a related function is performed. While it is preferred that an area is selected after the mode switch 910 switches an input mode, the present invention is not limited thereto. That is, functions could be performed without any mode switching in an embodiment of the present invention.

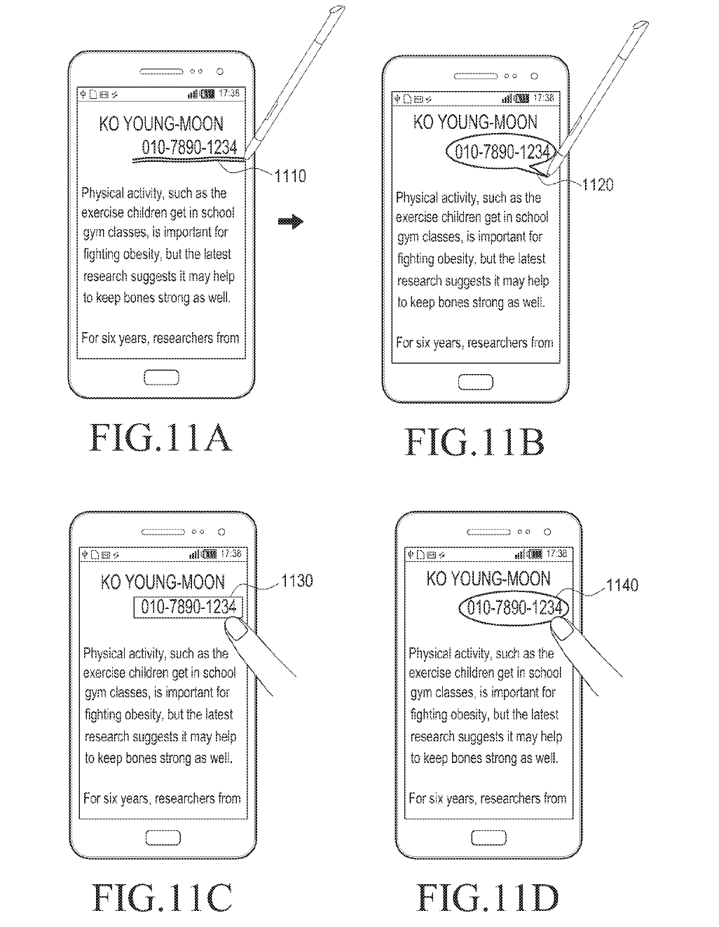

When the user selects a specific area on a screen by a user input applied through the input means, the selected area decider 920 determines the selected area. The user may select an area by a hand or pen touch. The user may select the area by drawing a closed loop (FIG. 11B) or an underline (FIG. 11A), or select the area from among a plurality of areas.

The selected area analyzer 930 analyzes the data type of the area selected by the input means. For example, the selected area analyzer 930 determines whether data included in the selected area is image data or text data. If the data included in the elected area is text data, the selected area analyzer 930 determines whether the text data is a character or a number. The selected area may have one or more data types.

The command detector 940 detects a command corresponding to the data type analyzed by the selected area analyzer 930 in a mapping table stored in the command storage 950. The command may request execution of a specific function in an electronic device, execution of a specific application installed in the electronic device, or execution of a specific function of a specific application along with execution of the specific application.

For example, when numbers are included in the selected area as illustrated in FIGS. 11A to 11D, the selected area analyzer 930 identifies text data included in the selected area as numbers. Thus, the command detector 940 executes a dialing program or a phonebook program as a function corresponding to the identified numbers. The identified numbers are used in the program. For example, the numbers are automatically inserted into a called number field by executing the dialing program or into a phone number field by executing the phonebook program.

The command detector 940 detects a plurality of commands corresponding to a specific data type. For example, if the analyzed data type of the selected area is numbers, a command of executing the dialing program, a command of executing a text sending program, and a command of executing the phonebook program are detected.

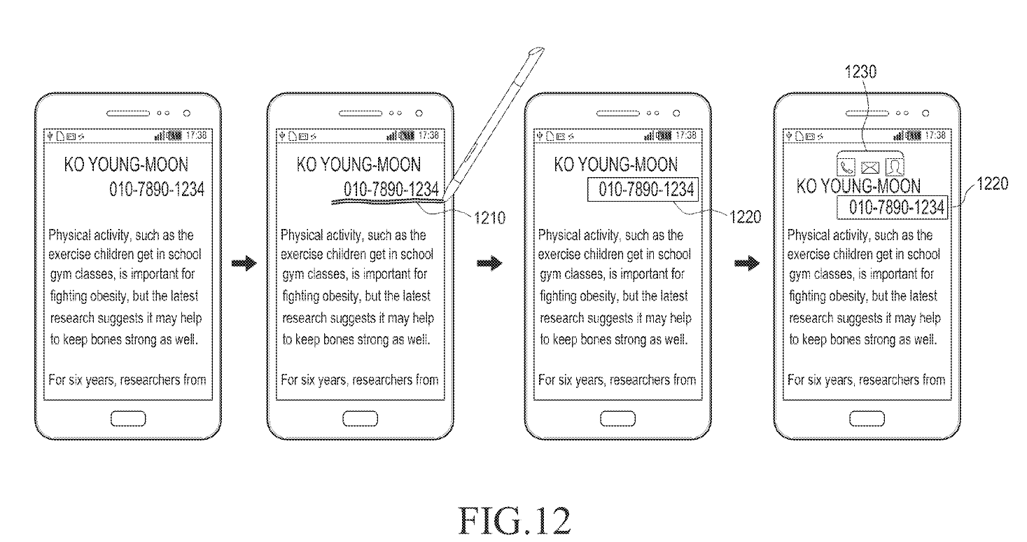

Accordingly, the menu display 960 displays a selection menu window displaying the detected program execution commands so that the user may select one of the detected program execution commands, as illustrated in FIG. 12. Thus, the user may select one of the execution programs displayed in the selection menu window and execute the selected program in relation to the selected area.

The command storage 950 stores at least one command mapped to each analyzed data type. For example, a command of executing a dialing program, an SMS service, or a phonebook program is mapped to numeral data, as previously described.

The command executer 960 executes the command detected by the command detector 940 or the command selected by the user from among the plurality of commands displayed on the menu display 960. When the command is executed, the data analyzed by the selected area analyzer 930 is considered. For example, if the command requests execution of the SMS service, numbers included in the selected area are automatically inserted into a phone number input field of an SMS transmission screen.

The components of the apparatus 900 are shown separately in FIG. 9 to indicate that they are functionally and logically separated. However, the components of the apparatus 900 are not necessarily configured as physical separate devices or codes.

Each function unit may refer to a functional and structural combination of hardware that implements the technical spirit of the present invention and software that operates the hardware. For example, each function unit is a logical unit of a specific code and hardware resources required to implement the code. Those skilled in the art will readily understand that a function unit is not always a physically connected code or a single type of hardware.

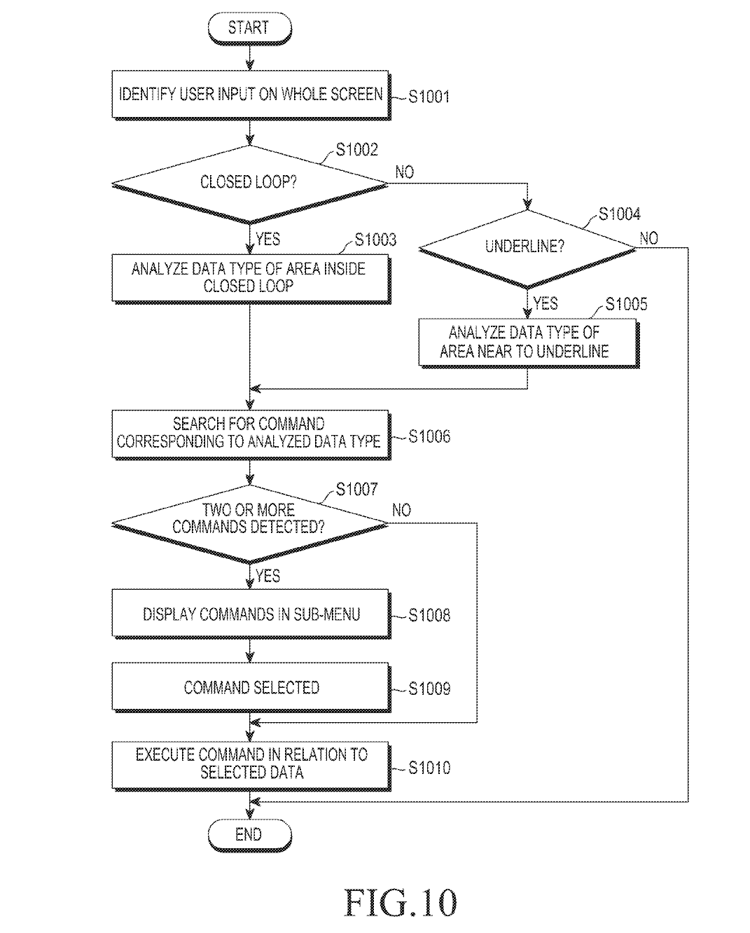

FIG. 10 illustrates an operation of executing a function related to a user input on a screen according to the second embodiment of the present invention. Referring to FIG. 10, a specific application is being executed in an electronic device and a user input is received on a current screen in step S1001. The shape of the user input is then identified.

If the user input is a closed loop in step S1002, the inside of the closed loop is determined to be a user-selected area and the type of data included in the closed loop is analyzed in step S1003. If the user input is an underline in step S1004, the type of data near to the underline is analyzed in step S1005.

A command corresponding to the analyzed data type is searched for in step S1006. If one command is detected, the command is executed using the data included in the selected area in step S1010. If two or more commands are detected in step S1007, the detected commands (or execution programs) are displayed as a sub-menu in step S1008.

When the user selects a specific one of the detected commands by means of the input means in step S1009, the selected command is executed using the data included in the selected area in step S1010.

FIGS. 11A to 11D illustrate execution of a function related to a user input on a screen according to the second embodiment of the present invention. Specifically, FIG. 11A illustrates an example of selecting a data area by underlining using an electronic pen,

FIG. 11B illustrates an example of selecting a data area by drawing a closed loop using an electronic pen, FIG. 11C illustrates an example of selecting a data area by selecting a text area with a finger, and FIG. 11D illustrates an example of selecting a data area by drawing a closed loop with a finger. Referring to FIG. 11A, when the user draws an underline 1110 in the command recognition mode, the type of data near to the underline 1110 is analyzed. For example, an area underlined by the underline 1110 or a data area a distance above the underline 1110 is regarded as a selected area and the data type of the selected area is analyzed. That is, since numbers (e.g. ‘010-7890-1234’) are located a distance above the underline 1110, the numbers are determined to be data included in the selected area. The data type of the selected area is analyzed to be numeral data.

In FIGS. 11B and 11D, a user selects areas by drawing closed loops 1120 and 1140, respectively, with an electronic pen or a finger. The areas defined by the selected closed loops 1120 and 1140 are analyzed and processed. In FIG. 11C, when the user drags a finger touch at a specific point on a screen, text 1130 at the dragged position is selected.

FIG. 12 illustrates execution of a function related to a user input on a screen according to the second embodiment of the present invention. Referring to FIG. 12, when a user draws an underline 1210 in a specific area on a screen with an electronic pen or the like, an area 1220 near to the underline 1210 (e.g. an area within a distance above the underline 1210) is regarded as a selected area, as described before with reference to FIG. 11A.

If data included in the selected area is numbers (or analyzed to be a phone number) as illustrated in FIG. 12, the dialing application is executed immediately and the numbers are inserted as a called phone number. If the data included in the selected area is numbers and a plurality of commands correspond to the numbers, the plurality of commands is displayed as an additional sub-menu 1230.

For example, a dialing icon, an SMS icon, and a phonebook icon are displayed, as illustrated in FIG. 12. When the user selects a specific icon, an application corresponding to the icon is executed and the numeral data of the selected area is automatically inserted in the execution screen of the application.

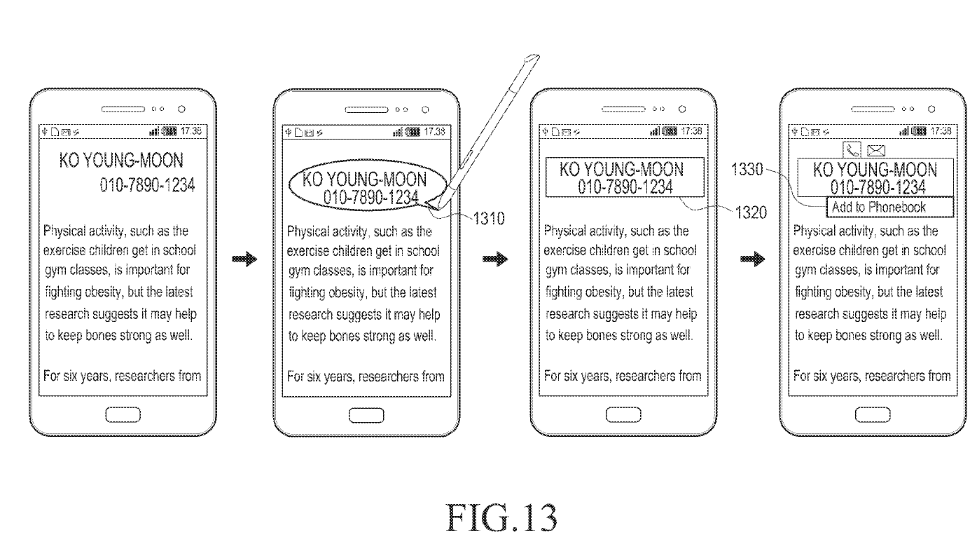

FIG. 13 illustrates execution of a function related to a user input on a screen according to the second embodiment of the present invention. Referring to FIG. 13, when a user draws a closed loop 1310 around a specific area on a screen, such as with an electronic pen, an area 1320 inside the closed loop 1310 is regarded as a selected area, as previously described with reference to FIGS. 11B and 11D.

If data in the selected area includes text and numbers as illustrated in FIG. 13, the phonebook application is executed immediately and the text and the numbers are inserted into a name field and a phone number field, respectively. In accordance with an embodiment of the present invention, an auxiliary window 1330 is displayed so that the user may directly select execution of the application. For example, the auxiliary window 1330 displays a message ‘Add to Phonebook’ as illustrated in FIG. 13. When the user selects the message, the data of the selected area is added to a phonebook.

As in FIG. 12, icons such as for dialing, SMS, and a phonebook are displayed in FIG. 13. When the user selects a specific icon, an application corresponding to the selected icon is executed and the text and numeral data of the selected area are automatically inserted in the execution screen of the application.

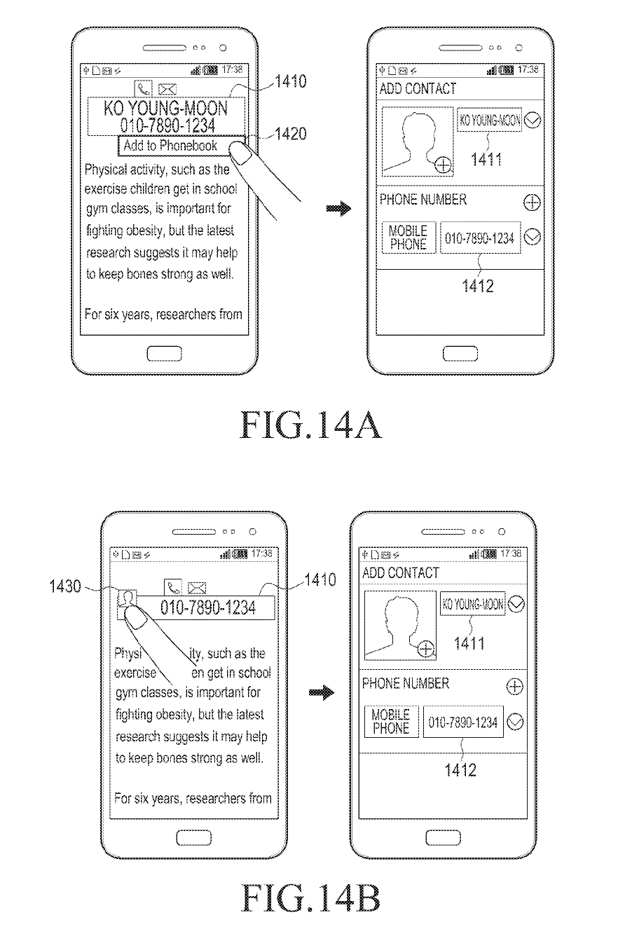

FIGS. 14A and 14B illustrate execution of a function related to a user input on a screen according to the second embodiment of the present invention. Referring to FIG. 14A, if a selected area 1410 includes text and numbers, an auxiliary window 1420 is displayed, for execution of a phonebook application, as illustrated in FIG. 13. When the user selects a message displayed in the auxiliary window 1420, the phonebook application is executed and the text and numbers of the selected area 1410 are automatically inserted into a name field 1411 and a phone number field 1412, respectively.

Referring to FIG. 14B, if the selected area 1410 includes text and numbers, as illustrated in FIG. 13, at least one icon corresponding to an application that executes a command related to the analyzed area is displayed. When the user selects a phonebook icon 1430 from among the displayed icons, the phonebook application is executed and the text and numbers of the selected area 1410 are automatically inserted into the name field 1411 and the phone number field 1412, respectively.

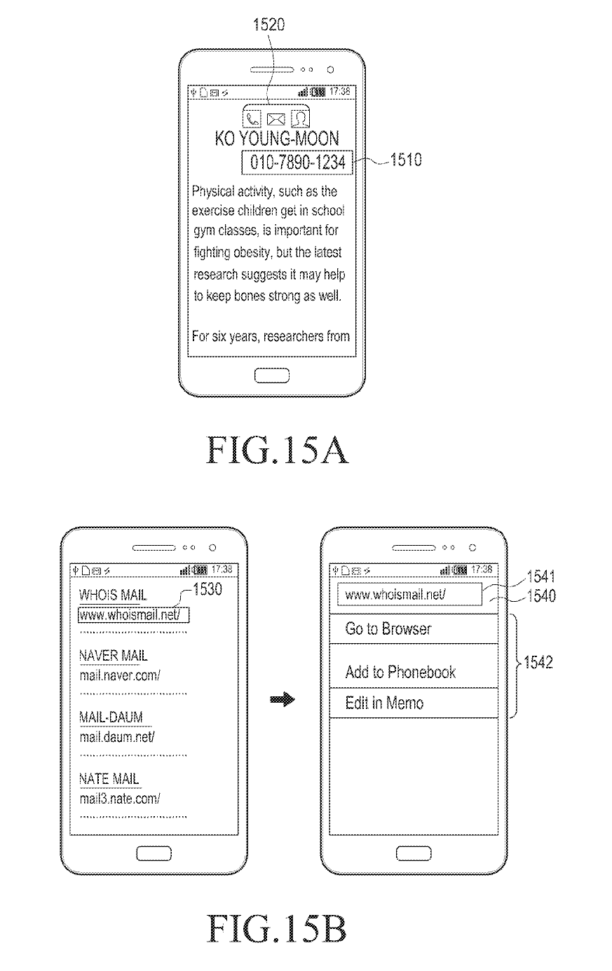

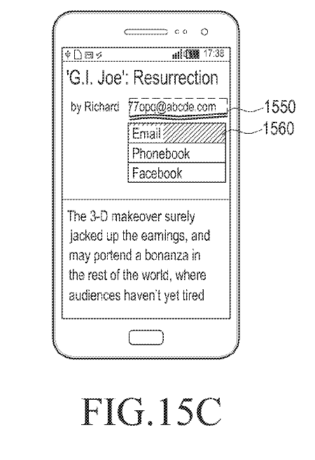

FIGS. 15A, 15B and 15C illustrate execution of a function related to a user input on a screen according to the second embodiment of the present invention. Referring to

FIG. 15A, if a selected area 1510 includes numbers, icons 1520 corresponding to a dialing application, a text sending application, and a phonebook application are displayed. When the user selects each icon, an application corresponding to the selected icon is executed and the numbers of the selected area 1510 are automatically added to the executed application.

Referring to FIG. 15B, if a selected area 1530 includes a Uniform Resource Locator (URL), a new window 1542 is generated to display a plurality of execution applications and the URL 1541 is automatically inserted. When the user selects a specific command in the window 1542, the command is executed in relation to the URL 1541 according to an embodiment of the present invention.

For example, if the user selects Go to Browser, a Web browser is executed and a Web site corresponding to the URL is displayed. If the user selects Add to Phonebook, the phonebook application is executed and the URL is automatically added to a URL input field. If the user selects Edit in Memo, a memo application is executed and the URL is automatically added as content of a memo.

Referring to FIG. 15C, if a selected area 1550 includes an e-mail address, a sub-menu window 1560 is generated to display a plurality of execution applications. When the user selects a specific application in the sub-menu window 1560, the application is executed in relation to the e-mail address. For example, when the user selects Email, an e-mail application is executed and the e-mail address is automatically added to a recipient address field. When the user selects Phonebook, the phonebook application is executed and the e-mail address is automatically added to an e-mail address input field. When the user selects a specific SNS, the SNS application is executed and the e-mail address is used in the SNS application.

As is apparent from the above description of the present invention, since an intuitive interface is provided according to a user selection, when needed, various functions related to data displayed on a screen are conveniently executed.

If a user wishes to execute a function related to data displayed on a screen of an electronic device, the user can execute the function by applying a handwriting input.

Embodiments of the present invention as described above typically involve the processing of input data and the generation of output data. This input data processing and output data generation are implementable in hardware or software in combination with hardware. For example, specific electronic components are employed in a mobile device or similar or related circuitry for implementing the functions associated with the embodiments of the present invention as described above. Alternatively, one or more processors operating in accordance with stored instructions may implement the functions associated with the embodiments of the present invention as described above. In this case, it is within the scope of the present invention that such instructions are stored on one or more processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present invention can be easily construed by programmers skilled in the art to which the present invention pertains.

While the present invention has been shown and described with reference to certain embodiments thereof, it will be understood by those skilled in the art that various changes in form and details can be made therein without departing from the spirit and scope of the invention as defined by the appended claims and their equivalents.

What is claimed is:

1. An apparatus of executing a function related to a user input, the apparatus comprising:
a touch screen configured to display data on a screen; and
a controller configured to analyze handwritten text, when at least a part of an area displayed on the touch screen is selected and the handwritten text is input by an input means, to detect at least one command corresponding to the analyzed text, and to control an execution of the detected command in relation to the selected area.

2. The apparatus of claim 1, wherein the controller controls the touch screen to display an auxiliary window on the touch screen if at least two commands corresponding to the analyzed text are detected, and
wherein the auxiliary window is to allow a user to select one of the detected commands.

3. The apparatus of claim 1, wherein the controller controls the touch screen to display images corresponding to the detected commands if at least two commands corresponding to the analyzed text are detected, and
wherein the images are displayed as icons on the touch screen.

4. The apparatus of claim 1, wherein the controller processes the handwritten text after a command input mode is set.

5. The apparatus of claim 1, wherein the controller searches commands included in a sub-menu of a currently executed application, with priority, in relation to the analyzed text.

6. The apparatus of claim 5, wherein the controller controls to extend the search to all commands when a detected command is not provided in the commands included in the sub-menu of the application.

7. The apparatus of claim 1, wherein the controller controls an execution of the detected command in relation to an entire area displayed on the touch screen.

8. The apparatus of claim 1, wherein the controller analyzes a type of data included in the selected area when the at least a part selected, detects at least one command corresponding to the analyzed data type, and controls an execution of the detected command in relation to the data included in the selected area.

9. The apparatus of claim 8, wherein the controller determines an area inside a closed loop to be the selected area if the closed loop is drawn on the touch screen by the input means.

10. The apparatus of claim 8, wherein the controller determines an area within a distance from an underline to be the selected area if the underline is drawn by the input means.

11. A method of executing a function related to a user input, the method comprising:
detecting selection of at least a part of an area displayed on a touch screen by an input means;
receiving handwritten text on the touch screen;
analyzing the handwritten text;
detecting at least one command corresponding to the analyzed text; and
executing the detected command in relation to the selected area.

12. The method of claim 11, further comprising displaying an auxiliary window on the touch screen if at least two commands corresponding to the analyzed text are detected,
wherein the auxiliary window is to allow a user to select one of the detected commands.

13. The method of claim 11, further comprising displaying images corresponding to the detected commands if at least two commands corresponding to the analyzed text are detected,
wherein the images are displayed as icons on the touch screen.

14. The method of claim 11, further comprising switching to a command input mode, before processing the handwritten text.

15. The method of claim 11, wherein commands included in a sub-menu of a current executed application are searched with priority, in relation to the analyzed text.

16. The method of claim 15, wherein the search is extended to all commands when a detected command is not provided in the commands included in the sub-menu of the application

17. The method of claim 11, further comprising executing the detected command in relation to an entire area displayed on the touch screen.

18. The method of claim 11, further comprising:
analyzing a type of data included in the selected area;
detecting at least one command corresponding to the analyzed data type; and
executing the detected command in relation to the data included in the selected area.

19. The method of claim 18, further comprising determining an area inside the closed loop is the selected area if a closed loop is drawn on the touch screen by the input means.

20. The method of claim 18, further comprising determining an area within a distance from an underline to be the selected area if the underline is drawn by the input means.
